(19) United States
(12) Patent Application Publication
(10) Pub. No.: US 2017/0061393 A1
(43) Pub. Date: Mar. 2, 2017

(54) SCHEDULE MANAGEMENT SYSTEM AND SCHEDULE MANAGEMENT METHOD USING CALENDAR

(71) Applicant: DAY2LIFE INC., Seongnam-si (KR)

(72) Inventors: Won Il PARK, Seoul (KR); Ki Chun LEE, Seoul (KR); Sang Wook KIM, Seoul (KR); Kyeonghun SEO, Seongnam-si (KR); Jongyi KIM, Gunpo-si (KR); Hyung-ook KIM, Gwangju-si (KR); Min Gyu KIM, Seoul (KR)

(21) Appl. No.: 15/348,288

(22) Filed: Nov. 10, 2016

Related U.S. Application Data
(63) Continuation-in-part of application No. PCT/KR2016/000717, filed on Jan. 22, 2016.

(30) Foreign Application Priority Data
Jan. 22, 2015 (KR) 10-2015-0010730

(51) Int. Cl. G06Q 10/10; G06F 17/27; G06F 3/0482

(52) U.S. Cl. CPC G06Q 10/1095; G06F 3/0482; G06F 17/2765; G06F 17/3097

(57) ABSTRACT

Provided is a schedule management method performed by a schedule management system using a calendar. The schedule management method may comprise: extracting a keyword from schedule information of a user input into multiple schedule input areas in the calendar; and outputting, on a schedule management apparatus of the schedule management system, at least one recommended schedule information selected in consideration of a similarity value between the extracted keyword and a set of multiple keywords classified by category, wherein the recommended schedule information is able to be added to a schedule input area on the calendar by selection of the user.

### CROSS-REFERENCE TO RELATED APPLICATION

This Application is a continuation in-part application of PCT Application No. PCT/KR2016/000717 filed on Jan. 22, 2016, which claims the benefit of Korean Patent Application No. 10-2015-0010730 filed on Jan. 22, 2015, the entire disclosures of which are incorporated herein by reference

### TECHNICAL FIELD

The present disclosure relates to a schedule management apparatus using a calendar and a schedule management method by means of a schedule management system.

### BACKGROUND

Recently, with the advancement of computer-related technologies or mobile technologies, calendar programs for computer or calendar applications for mobile have been developed. The calendar programs for computer can be easily used at home or office, and the calendar applications for mobile solve the volume problem of conventional diaries or planners and provide an alarm function and thus are being used by many people.

Meanwhile, in recent years, as events, performances, lectures, seminars, etc. are increased in number and various in kind, it becomes difficult for users to search external schedules of interest every time. Therefore, each of the users wants to be provided with information about the external schedules of interest in a batch. To this end, the users may use an event information providing service (e.g., application, sharing calendar, newsletter, etc.) to directly check information about a preferred event, automatically update their own calendars with the information, or automatically receive the information by email.

However, a conventional service that provides schedule information in a batch causes a user inconvenience of personally applying for subscription service or accessing a homepage that provides the service. Further, in case of using calendar subscription, all schedules are provided by a calendar subscription service provider in a batch regardless of interests of the user.

Meanwhile, Korean Patent Laid-open Publication No. 10-2011-0043842 (entitled “User adaptive recommendation system”) discloses a user adaptive recommendation system that generates a group of users with similar preferences on the basis of users' preference information about each item of product and provides product recommendation to the users included in the group.

### SUMMARY

In view of the foregoing, an exemplary embodiment of the present disclosure provides a system which automatically selects recommended schedules (e.g., a summary of news articles, event/lecture schedules, etc.) from a digital calendar in consideration of a user's personal tendency and preference and provides the selected schedules to the user, and enables the user to easily add the recommended schedules to the digital calendar, and a schedule management method.

However, problems to be solved by the present disclosure are not limited to the above-described problems. There may be other problems to be solved by the present disclosure.

According to an exemplary embodiment of the present disclosure, the schedule management method may comprise: extracting a keyword from schedule information of a user input into multiple schedule input areas in the calendar; and outputting, on a schedule management apparatus of the schedule management system, at least one recommended schedule information selected in consideration of a similarity value between the extracted keyword and a set of multiple keywords classified by category, wherein the recommended schedule information is able to be added to a schedule input area on the calendar by selection of the user.

Herein, the recommended schedule information is added as schedule information to the calendar by selection of the user.

According to another exemplary embodiment of the present disclosure, a schedule management apparatus using a calendar may comprise : a memory in which a calendar program managing a schedule is stored; and a processor which executes the calendar program, wherein the processor performs: extracting a keyword from schedule information of a user input into multiple schedule input areas in a calendar provided by the calendar program; and outputting, on a screen of the schedule management apparatus, at least one recommended schedule information selected in consideration of a similarity value between the extracted keyword and a set of multiple keywords classified by category, in response to an instruction of the calendar program, and the recommended schedule information is able to be added to a schedule input area on the calendar by selection of the user.

Herein, the recommended schedule information is added as schedule information to the calendar by selection of the user.

According to yet another exemplary embodiment of the present disclosure, the schedule management method may comprise creating a user profile on the basis of a usage history of a user about recommended schedule information provided to the user; creating recommended schedule information on the basis of a similarity value between the user profile and external schedule information received from an external schedule database; and outputting the recommended schedule information on a schedule management apparatus of the schedule management system, wherein the user profile includes keyword information representing schedule information determined as being preferred by the user on the basis of the usage history, in the creating of recommended schedule information, the external schedule information is ranked and produced on the basis of a similarity value between a keyword included in the user profile and keywords defining a category classifying the external schedule information, and in the creating of a user profile, schedule information preferred by the user is checked on the basis of any one or more of whether or not the user scraps the recommended schedule information or whether or not the user reflects the recommended schedule information as a schedule of the user.

Herein, the output recommended schedule information and the re-output recommended schedule information are added as schedule information to the calendar by selection of the user.

According to any one of the exemplary embodiments of the present disclosure, preference about a category preferred by a user can be estimated from schedule information input into a calendar by the user. Thus, it is possible to provide recommended schedule information in consideration of preference of the user.

Further, according to an exemplary embodiment of the present disclosure, an interface through which recommended schedule information can be easily added to a digital calendar is provided. Thus, it can be helpful for a user in efficiently managing a schedule.

Furthermore, according to an exemplary embodiment of the present disclosure, the recommended schedule usage history of a user can be collected to estimate preference of the user. Thus, it is possible to provide recommended schedule information with high probability and accuracy of being preferred by the user from among external schedule information.

Moreover, according to an exemplary embodiment of the present disclosure, preference of a specific user can be estimated by collecting and analyzing information of other users having similar tendencies to that of the specific user together. Thus, it is possible to provide sufficient recommended schedule information close to the preference of the specific user.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a schematic conceptual diagram of a schedule management system in accordance with an exemplary embodiment of the present disclosure.

FIG. 2 is a block diagram of a schedule management apparatus in accordance with an exemplary embodiment of the present disclosure.

FIG. 3 is a flowchart of a schedule management method by means of a schedule management system in accordance with an exemplary embodiment of the present disclosure.

FIG. 4 is a diagram provided to explain a specific modification example of the schedule management method illustrated in FIG. 3.

FIG. 5 is a diagram provided to explain another specific modification example of the schedule management method illustrated in FIG. 3.

FIG. 6 illustrates an example of a user interface of a schedule management program in accordance with an exemplary embodiment of the present disclosure.

FIG. 7A is a diagram provided to explain an example of the use of a recommended schedule information button in accordance with an exemplary embodiment of the present disclosure.

FIG. 7B is a diagram provided to explain another example of the use of a recommended schedule information button in accordance with an exemplary embodiment of the present disclosure.

FIG. 7C is a diagram provided to explain yet another example of the use of a recommended schedule information button in accordance with an exemplary embodiment of the present disclosure.

FIG. 8A is a diagram provided to explain an example of the use of a memo input area button in accordance with an exemplary embodiment of the present disclosure.

FIG. 8B is a diagram provided to explain another example of the use of a memo input area button in accordance with an exemplary embodiment of the present disclosure.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for simplicity of explanation.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements unless context dictates otherwise.

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for simplicity of explanation.

Further, in the following explanation with reference to the accompanying drawings, components bearing the same name may be assigned different reference numerals depending on a drawing. A reference numeral is assigned only for convenience in explanation, and a concept, feature, function, or effect of each component should not be limitedly construed by the corresponding reference numeral.

An exemplary embodiment of the present disclosure relates to a method of providing a recommended schedule on a digital calendar installed in a user device by reflecting preference of a user and adding a recommended schedule selected by the user to the digital calendar. Further, in an exemplary embodiment of the present disclosure, preference of a user can be estimated using at least one of the texts in schedule information directly input by the user, analysis information about the recommended schedule usage history of the user, analysis information about the usage history of other users using the same digital calendar. Furthermore, in an exemplary embodiment of the present disclosure, various methods for estimating preference are combined to select recommended schedule information in consideration of preference of a user, so that it is possible to recommended schedule information closer to an area of interest of the user.

Hereinafter, a schedule management method by means of a schedule management system using a calendar and a schedule management apparatus in accordance with the present disclosure will be described in detail with reference to the accompanying drawings.

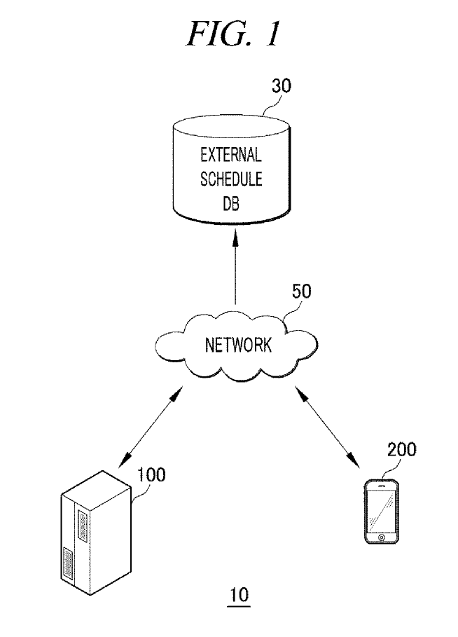

FIG. 1 is a schematic conceptual diagram of a schedule management system in accordance with an exemplary embodiment of the present disclosure.

As illustrated in FIG. 1, a schedule management system 10 in accordance with an exemplary embodiment of the present disclosure includes an external schedule database 30, a schedule management server 100, and a schedule management apparatus 200 which are connected to each other via a network 50. However, the schedule management system 10 illustrated in FIG. 1 is just an exemplary embodiment of the present disclosure and the present disclosure should not be limitedly construed by FIG. 1. That is, according to various exemplary embodiments of the present disclosure, the schedule management system 10 may have a different configuration from that illustrated in FIG. 1.

The external schedule database 30 stores therein various kinds of external schedule information (news, movie, concert, play, sports, music, etc.), which is a content generated by an advertiser, classified by category. Further, the external schedule database 30 may additionally store therein multiple keyword sets representing categories. The multiple keyword sets stored in the external schedule database 30 may be supplied as comparative data to the schedule management server 100 or the schedule management apparatus 200 and then used to calculate a similarity to schedule information of a user.

The schedule management server 100 transmits and receives a signal or information for providing recommended schedule information customized for the user to the schedule management apparatus 200. Further, the schedule management server 100 may control a schedule management program of the schedule management apparatus 200 to provide a recommended schedule to the schedule management apparatus 200.

The schedule management apparatus 200 ranks an information list for each category in the external schedule database 30, or transmits and receives a signal or information for receiving the ranked information list.

Herein, the schedule management apparatus 200 may calculate a similarity between schedule information input into a calendar by the user and multiple keywords representing the categories in the external schedule database 30, estimate a category preferred by the user, and provide a recommended schedule accordingly.

Further, the schedule management apparatus 200 may calculate preference of the user and provide the user schedule management apparatus 200 with recommended schedule information which is ranked external schedule information in the external schedule database 30.

The schedule management apparatus 200 may be a kind of application which can be downloaded and installed to the schedule management server from a market such as an app store or an application providing server, but is not limited thereto. For reference, the schedule management apparatus 200 is a wireless communication device that ensures portability and mobility and may include all kinds of handheld-based wireless communication devices such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), WiBro (Wireless Broadband Internet) device, smart phone, and the like. In particular, the schedule management apparatus 200 is an intelligent device equipped with computer supporting functions such as an Internet communication function and an information search function in addition to a mobile device, and may be a smart phone in which multiple application programs (e.g., applications) the user wants can be installed and executed.

Generally, the components constituting the schedule management system 10 illustrated in FIG. 1 are connected to each other through the network 50. The network 50 refers to a connection structure that enables information exchange between nodes such as multiple devices and servers. Examples of the network may include a 3GPP (3rd Generation Partnership Project) network, an LTE (Long Term Evolution) network, a WIMAX (World Interoperability for Microwave Access) network, the Internet, a LAN (Local Area Network), a Wireless LAN (Wireless Local Area Network), a WAN (Wide Area Network), a PAN (Personal Area Network), a Bluetooth network, a satellite broadcasting network, an analog broadcasting network, a DMB (Digital Multimedia Broadcasting) network, and the like, but are not limited thereto.

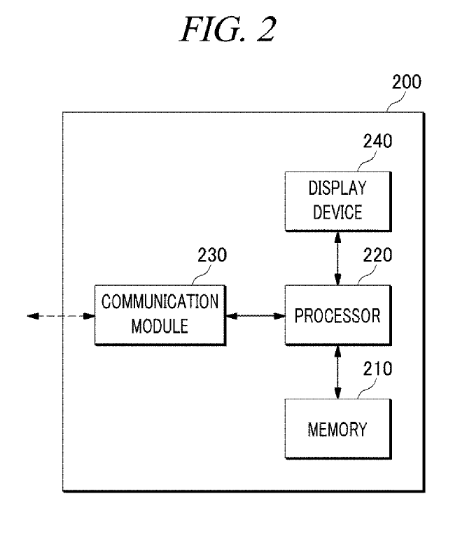

FIG. 2 is a block diagram of a schedule management apparatus in accordance with an exemplary embodiment of the present disclosure.

A schedule management apparatus 200 using a calendar in accordance with an exemplary embodiment of the present disclosure includes a memory 210, a processor 220, a communication module 230, and a display device 240.

The memory 210 stores a calendar program (hereinafter, referred to as “schedule management program”) that manages a schedule.

The processor 220 executes the schedule management program stored in the memory.

The processor 220 performs: extracting a keyword from schedule information of a user input into a calendar provided by the schedule management program; and outputting, on the calendar, at least one recommended schedule information selected in consideration of a similarity between the extracted keyword and a set of multiple keywords classified by category, in response to an instruction of the calendar program. Herein, the recommended schedule information may be added as schedule information to a schedule input area on the calendar by selection of the user.

The communication module 230 receives multiple external schedule information from the server. In this case, the processor 220 may perform outputting recommended schedule information selected from the information of the multiple external schedules.

Further, the communication module 230 receives preference of external users about each category from the server, and the processor 220 may perform the following processes when outputting the recommended schedule information. The processor 220 may perform: calculating preference of the user about each category on the basis of the similarity; selecting at least one similar user from among the external users by comparing a user similarity between the calculated preference and the received preference of the external users; and selecting recommended schedule information in consideration of preference of the selected similar user about each external schedule. In this case, the schedule management apparatus 200 itself may perform various operations for outputting the recommended schedule information.

Further, the communication module 230 may transmit preference of the user about each category calculated by the processor 220 on the basis of the similarity to the server, and receive information about the similar user from the server. The processor 220 may perform selecting recommended schedule information in consideration of preference of the similar user about each external schedule when outputting the recommended schedule information. Herein, the similar user may be selected by the user on the basis of a user similarity between the transmitted preference and the preference of the external users about each category.

In this case, the schedule management apparatus 200 and the server may cooperate in various operations for outputting the recommended schedule information. That is, the server may perform an operation for recommendation and the schedule management apparatus 200 may perform a responsive interactive operation with the user through communication with the server.

The display device 240 displays external schedule information on the screen of the schedule management apparatus 200. In this case, the display device 240 preferentially displays the recommended schedule information reflecting the preference of the user at the top of each category of the external schedule information. Further, the display device 240 may also provide detailed information of recommended schedules together with the external schedule information.

In addition, the display device 240 may perform displaying various kinds of information to the user and directly receiving the user's input by a touch system. The calculation, selection, and recommendation operations of the processor 220 are performed by the schedule management server 100, and the schedule management apparatus 200 may be implemented to revive a result value from the server and output the result value.

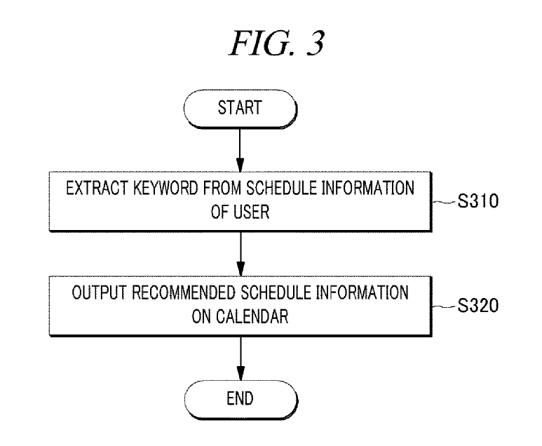

FIG. 3 is a flowchart of a schedule management method by means of a schedule management system in accordance with an exemplary embodiment of the present disclosure.

The schedule management method by means of the schedule management system using a calendar in accordance with an exemplary embodiment of the present disclosure includes: extracting a keyword from schedule information of a user (S310); and outputting recommended schedule information on the calendar (S320).

For reference, external schedule information provided to the user includes about 20 categories (travel, movie, sports, etc.), and each category may include a set of multiple keywords relevant to the category. A “Travel” category may include a set of multiple keywords such as “Trip”, “Tour”, “Tracking”, “Vacation”, and the like. Preference of the user about the “Travel” category can be calculated by extracting a keyword from schedule information input by the user and calculating a similarity showing how the extracted keyword is similar to the set of multiple keywords relevant to the “Travel” category. In other words, keywords are extracted from all of schedule information freely input by the user and whether or not there is a common keyword between the extracted keywords and multiple keywords relevant to each category is determined, so that a similarity value can be extracted and preference of the user about each category can be checked. Further, the preference is estimated from the extracted keywords and a schedule input area on the calendar where the schedule information of the user is input, or by giving different weightings to respective execution times of schedule information which are future times for executing schedules by the user. Accordingly, the schedule management method suggested in the present disclosure can provide recommended schedule information closer to preference of a user.

In S310, a keyword is extracted from schedule information of a user input into a calendar. A keyword is extracted from schedule information of a user freely input by the user into a schedule input area (daily schedule input area, to-do input area, memo input area, etc.) provided by a calendar application.

Then, in S320, at least one recommended schedule information selected in consideration of a similarity between the extracted keyword and a set of multiple keywords classified by category is output on the calendar.

S320 may include: calculating preference of the user about each category on the basis of the similarity; quantifying correlations between each category and information of multiple external schedules; and determining the order of outputting the external schedule information as recommended schedule information by ranking the external schedule information on the basis of the calculated preference and the quantified correlations. Herein, the recommended schedule information may be ranked by reflecting the preference of the user about the external schedule information.

In other words, the schedule management system does not provide external schedule database information as it is, but provides user-customized recommended schedule information to each user by reflecting preference of the user. That is, the external schedule database may be ranked by reflecting preference of the user about each category.

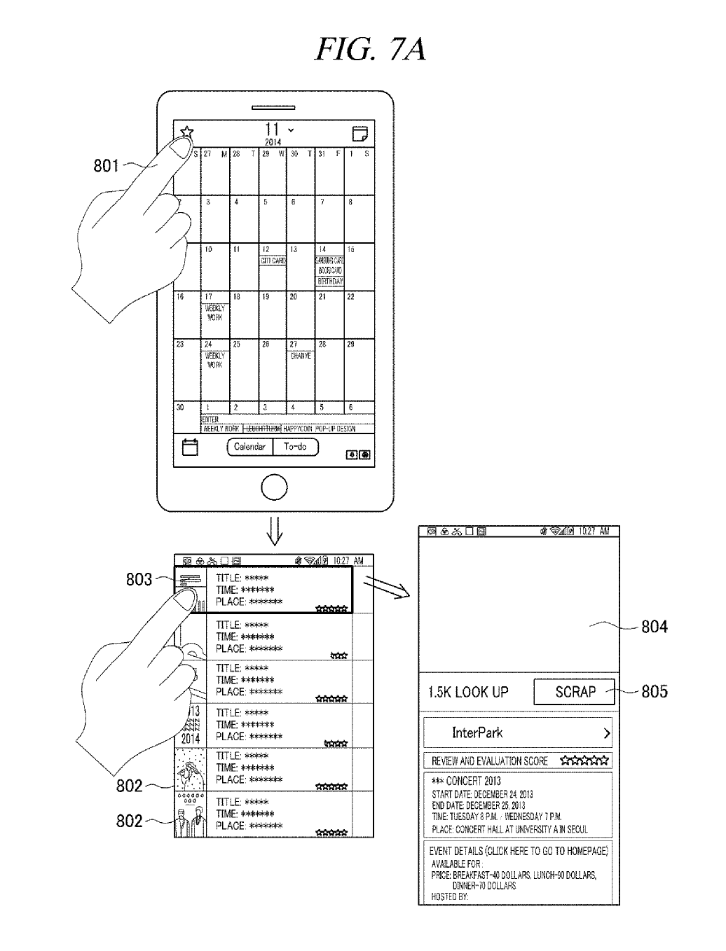

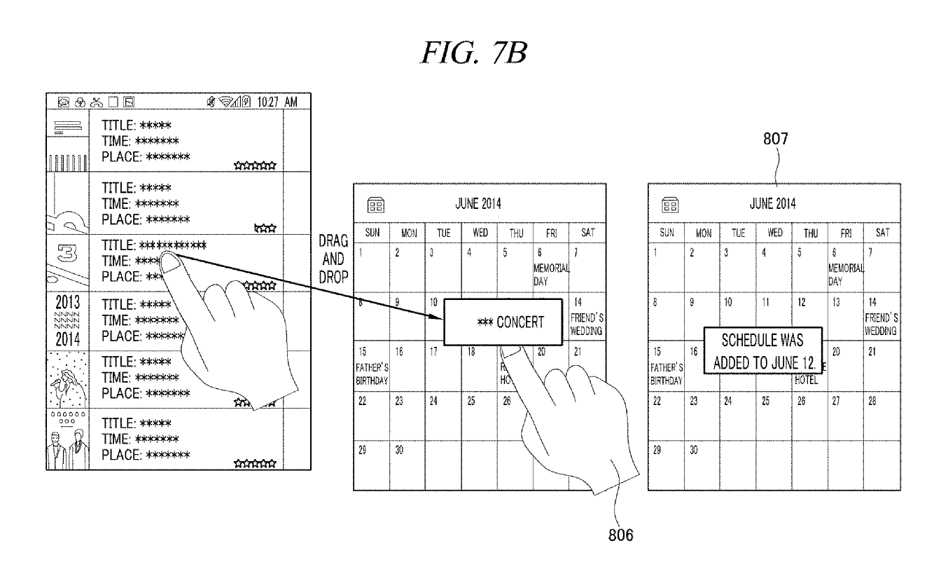

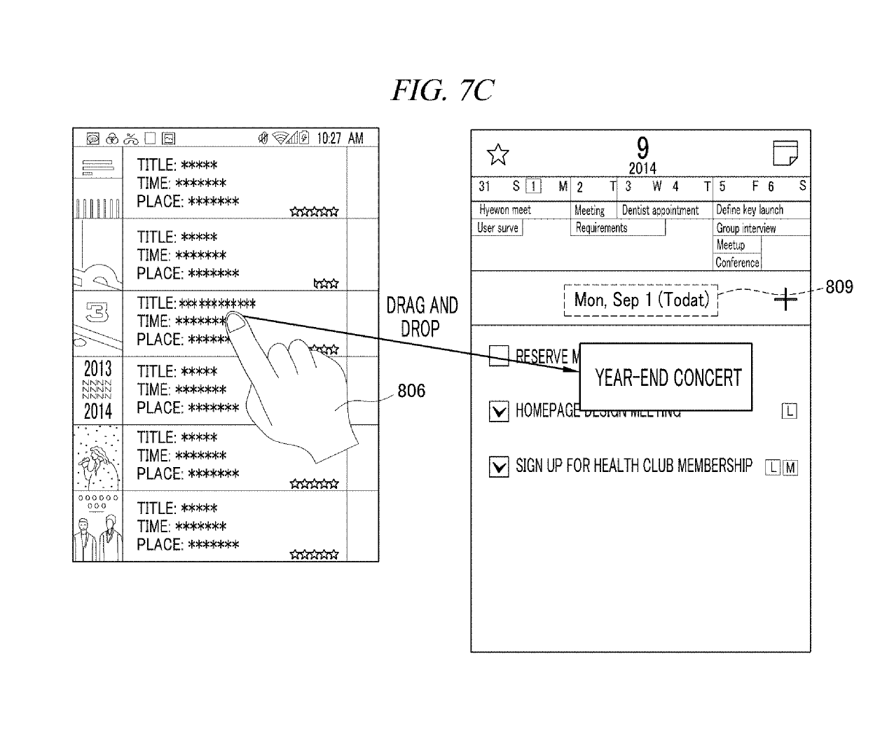

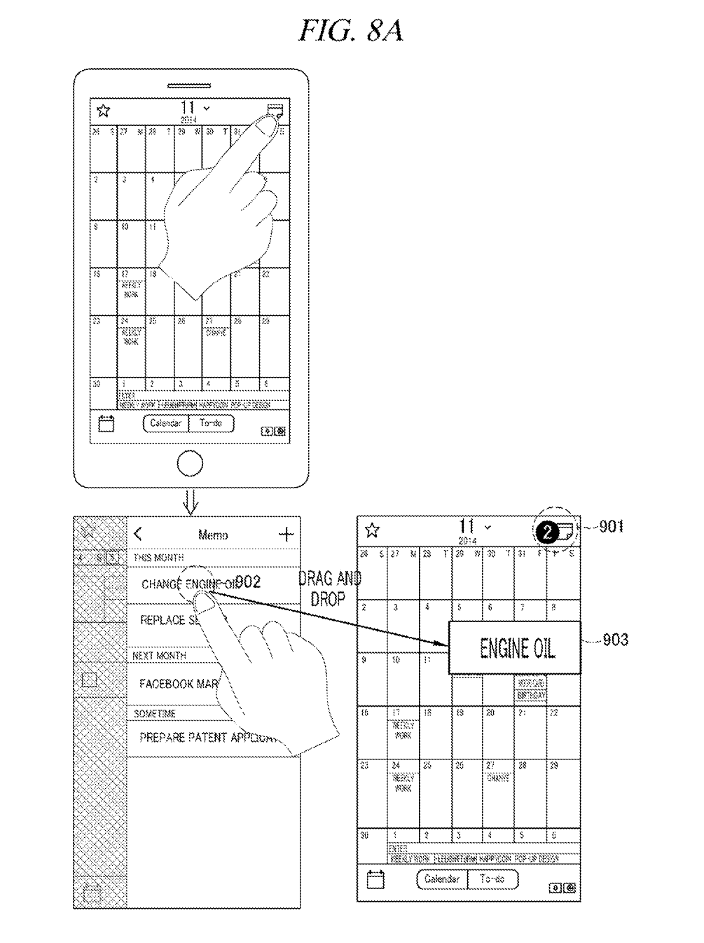

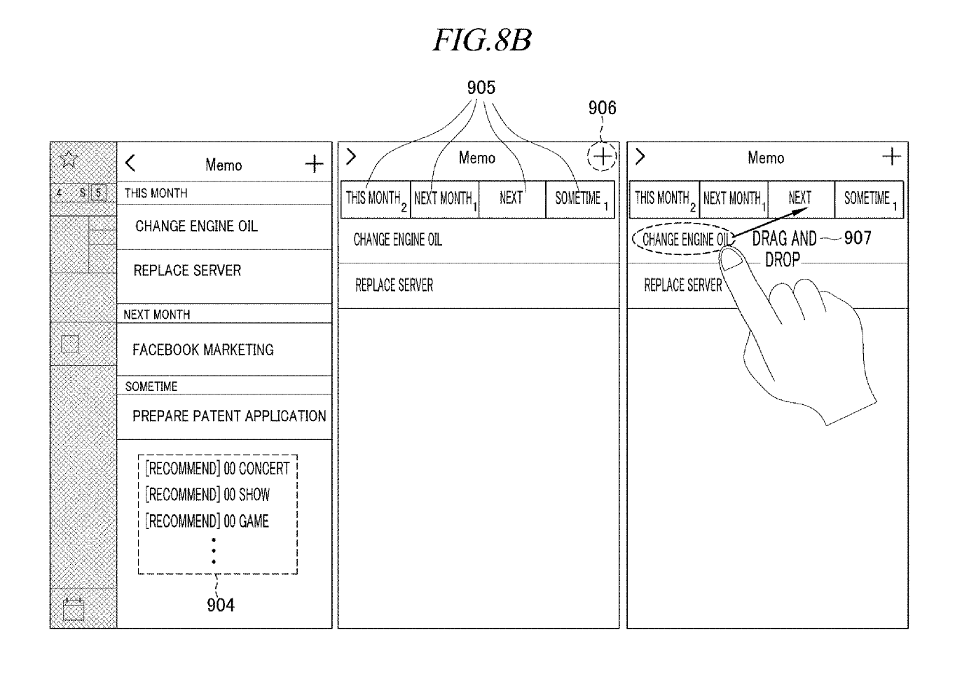

Herein, the recommended schedule information is added as schedule information to the schedule input area on the calendar by selection of the user. For example, a recommended schedule may be added to the daily schedule input area for the user by dragging and dropping the corresponding recommended schedule information to the calendar. Further, a recommended schedule may be added to the memo input area for the user by using a scrap function provided in a detailed information tab for the recommended schedule. Furthermore, a recommended schedule may be added to the to-do input area by touching the corresponding recommended schedule information for a predetermined time. A recommended schedule reflected as the user's schedule is used as information for estimating preference of the user. Exemplary embodiments of reflecting a recommended schedule as a user's schedule will be described in detail with reference to FIG. 7A through FIG. 8B.

Hereinafter, there will be described additional consideration for more accurate estimation of preference of the user when calculating the preference of the user.

In order to more accurately estimate preference of the user, identifying a predetermined schedule input area where schedule information is input from among multiple schedule input areas in the calendar may be further included. The schedule input areas may be previously set to be respectively given different weightings with close relevance to an execution time of schedule information input by the user.

According to an exemplary embodiment, the multiple schedule input areas may include a daily schedule input area provided for each date, a to-do schedule input area provided for each predetermined period, and a memo schedule input area provided randomly.

In an example, the highest weighting may be given to schedule information input into the daily schedule input area among the multiple schedule input areas, and the lowest weighting may be given to schedule information input into the memo schedule input area among the multiple schedule input areas. This is because the user tends to input a schedule (specific date) or a to-do (predetermined period) of which an execution time is specifically determined into the daily schedule input area or the to-do schedule input area and input a long-term plan of which an execution time is not specifically determined into the memo schedule input area.

In another example, a similarity may be calculated by giving a similarity value of each extracted keyword a higher weighting when an execution time corresponding to the identified schedule input area is closer to when the recommended schedule information is provided to a user. The highest weighting may be given to present and future schedule information among the input schedule information, and the lowest weighting may be given to schedule information relevant to the far future. This is because the user tends to be more interested in schedule information for the present and near future.

Further, as will be described later, the memo schedule input area may be subdivided into a first subdivided schedule input area for a to-do to be executed in the near future, a second subdivided schedule input area for a to-do to be executed in the far future, and a third subdivided schedule input area for lightly describing random contents, and different weightings may be given to respective execution times of schedule information in each of the subdivided schedule input areas.

In addition, identifying a frequency of schedule information input into the multiple schedule input areas in the calendar may be further included. Herein, in the outputting of recommended schedule information, calculation may be performed by giving a different weighting depending on the identified frequency of schedule information of the user. In this case, the highest weighting may be given to repeatedly input schedule information among the input schedule information, and the lowest weighting may be given to schedule information with a low frequency. This is because the user tends to be more interested in schedule information with a high frequency among the input schedule information.

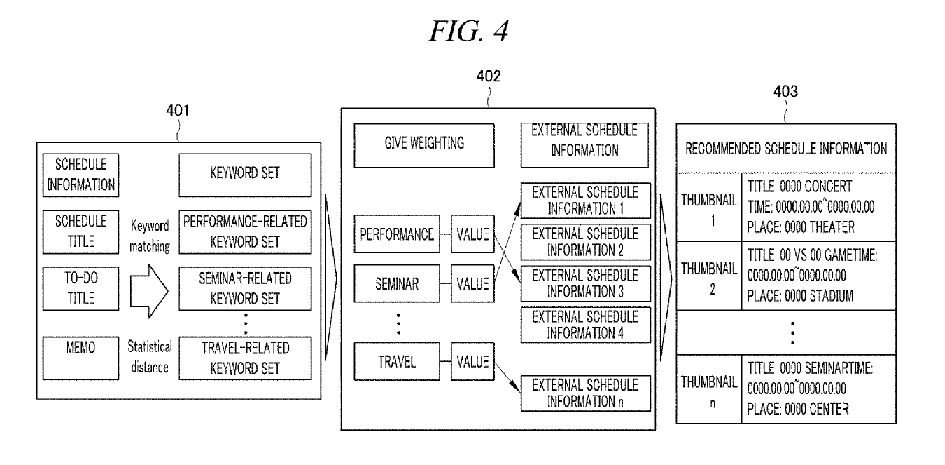

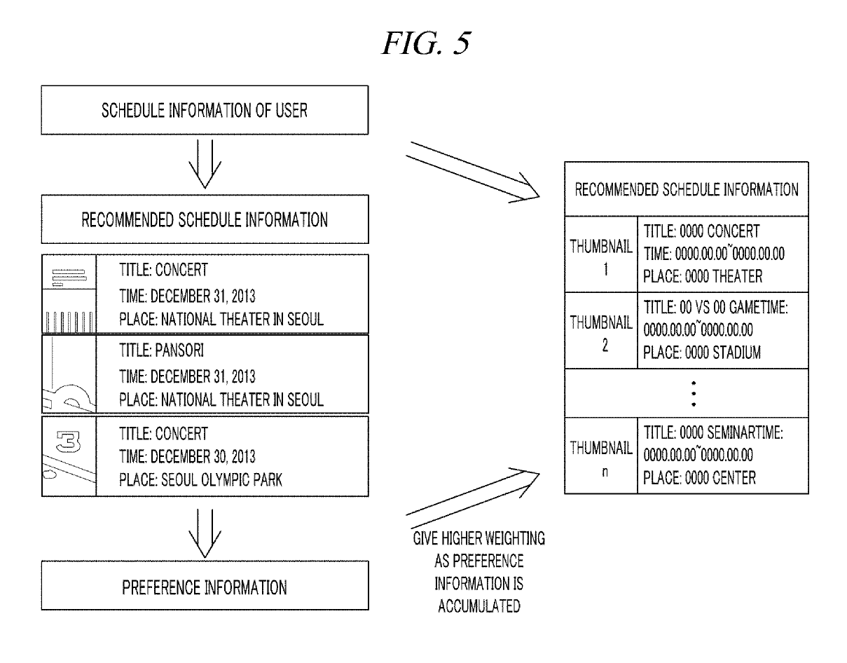

FIG. 4 and FIG. 5 are diagrams provided to explain specific modification examples of the schedule management method illustrated in FIG. 3.

Referring to FIG. 4 in detail, the schedule management method includes a process of extracting a keyword from schedule information of the user and determining a similarity between the extracted keyword and a set of multiple keywords (401), a process of giving a weighting using information for further specifying preference of the user (402), and a process of providing a recommended schedule reflecting the calculated preference (403).

In the process 401, keywords are extracted from user schedule information input into the input areas (daily schedule input area, to-do input area, memo input area, etc.) provided on the calendar, and similarities to multiple keyword sets representing categories of external schedule information are calculated.

Specifically, assuming that external schedule categories are C=<C₁, C₂, . . . , Cₘ>, multiple keywords included in a category j are Cⱼ=<Ck₁, Ck₂, . . . , Ckₗ_{ⱼ}>, and weightings of keywords are Wᵢ=<wᵢ₁, wᵢ₂, . . . , wᵢₘ_{ᵢ}>, similarities between the multiple keyword sets representing the categories and schedule information of the user can be determined and preference of the user can be estimated.

A similarity (i.e. PMI : Point Mutual Information) can be obtained using Equation 1. The similarity between the schedule information and the multiple keyword sets can be obtained by calculating a reciprocal value for a distance such as a Levenshtein distance. An interest P=<P₁, P₂, . . . , Pₘ> of the user about each category can be obtained by Equation 1.

Pᵢ=exp(−constant*∥k−Ck∥²) [Equation 1]

In the process 402, if the interest P=<P₁, P₂, . . . , Pₘ> of the user about each category is obtained, different weightings may be given to the past, the present, and the future in order to estimate preference of the user with more accuracy. The user may be more interested in schedule information for the present and the future than schedule information for the past, and, thus, the schedule information for the current and the future may be given higher weightings.

Specifically, assuming that text of items input in the past is k=<k₁₁, k₁₂, . . . , k₁ₙ_{₁}>, keywords relevant to the present are k₂=<k₂₁, k₂₂, . . . , k₂ₙ_{₂}>, text of items relevant to the future is k₃=<k₃₁, k₃₂, . . . , k₃ₙ_{₃}>, and weightings given to them are α, β, and γ, the sum Pₖ of similarities between the keywords of the input schedule of the user and the keywords Cᵢ=<Ck₁, Ck₂, . . . , Ckₗ_{ⱼ}> in the category j can be obtained using Equation 2.

$${P}_{k} = exp ( - α {\sum }_{i = 1}^{{n}_{1}} {\sum }_{j = 1}^{{l}_{j}} {‖ {k}_{i} - {Ck}_{j} ‖}^{2} {W}_{j} - β {\sum }_{i = 1}^{{n}_{2}} {\sum }_{j = 1}^{{l}_{j}} {‖ {k}_{i} - {Ck}_{j} ‖}^{2} {W}_{j} - γ {\sum }_{i = 1}^{{n}_{3}} {\sum }_{j = 1}^{{l}_{j}} {‖ {k}_{i} - {Ck}_{j} ‖}^{2} {W}_{j} ) . \qquad [ Equation 2 ]$$

Thus, it is possible to preferentially recommend external schedule information relevant to the present and the future. Further, the future may be subdivided into 1-month future, 3-month future, and far future. Additional terms may be made in the same manner to separately give weightings to the times.

In the process 403, assuming that category importance of external schedule information is CW=<CW₁, CW₂, . . . , CWₘ>, external schedule information with a high product of the interest of the user and the category importance of an external plan Score=P·CW is preferentially provided.

Meanwhile, a schedule management method by means of a schedule management system using a calendar in accordance with another exemplary embodiment of the present disclosure may further include: identifying a user through a log-in process; and collecting and analyzing specific recommended schedule information to which the identified user reacts from among output recommended schedule information as preferred information of the identified user. Herein, in the outputting of recommended schedule information, the recommended schedule information is selected in consideration of a similarity and preferred information.

Herein, the specific recommended schedule information may be at least any one of recommended schedule information clicked at least a reference number of times, recommended schedule information given a minimum or higher evaluation score, recommended schedule information added as schedule information to the calendar, and recommended schedule information which is scrapped.

The method includes: a process of creating a user profile by analyzing a usage history of the user; a process of giving a weighting using information for further specifying preference of the user; and a process of providing recommended schedule by reflecting a calculated preference.

In the process of creating a user profile, the user profile is created by analyzing the usage history of the user. If the user starts receiving external schedule information, the user may perform clicking, giving an evaluation score, scrapping, reflecting as his/her schedule with respect to an external plan. In this case, the user profile can be created by analyzing external schedule information preferred by the user. For example, the profile can be created by analyzing usage information of the user depending on a case where a recommended schedule receives the number of clicks equal to or higher than a threshold value, a case where a recommended schedule is given a score of 8 out of 10, a case where a recommended schedule is scrapped, and a case where a recommended schedule is reflected as the user's schedule.

Specifically, in order to create the user profile, it is necessary to analyze an external plan preferred by the user. External schedule information can be expressed by an external plan feature which is a vector consisting of keywords. A feature of external schedule information i is defined as Eᵢ=<k₁, k₂, . . . , kₘ>, and if a keyword j is included in the external schedule information i, kⱼ is 1, or if not, kⱼ is 0. Herein, m represents the number of all keywords in the whole schedule information.

In the process of giving a weighting, the weighting is given using information for further specifying preference of the user. The user profile is also expressed as the sum of weightings in consideration of the external plan feature which is a vector consisting of keywords and meets four standards of an external plan preferred by the user with time. A preferred external plan is divided by time into past, present, and future, and a weighting of time may be defined as αₖ(k=1 to 3).

For example, a user profile for the past may be defined as Q₁ⱼ=<xᵢ₁, xᵢ₂, . . . , xᵢₘ> and xⱼ may represent the number of times for the keyword j to be included in a past external plan preferred by the user. Further, a user profile Q₂ᵢ for the present and a user profile Q₃ᵢ for the future can be defined in the same manner. In order to reflect a change in user profile with respect to time, Pᵢ=Σₖ₌₁³αₖQₖᵢ may be defined by multiplying a user profile by a weighting αₖ of time corresponding to an external plan preferred by the user.

Herein, a term for each time may be subdivided into, for example, 1-month future, 3-month future, and far future, and additional terms may be made in the same manner to separately give weightings to the times.

For reference, subdivision can be carried out depending on a schedule input area (e.g., daily schedule input area, to-do input area, and memo input area) where schedule information of the user is input or a frequency of a keyword in schedule information of the user. In the same manner as the method of giving a weighting to time described above, a term corresponding to a schedule input area or a frequency can be added to the equation together with a separate weighting.

In the process of providing a recommended schedule, the recommended schedule is provided by reflecting the calculated preference. It is possible to calculate which external schedule information has a high similarity to the user profile from among external schedule information which have not yet been opened by the user (i.e. not included in the user profile). A cosine similarity between the user profile and the external plan feature can be calculated using Equation 3. If the calculation of similarities to all of external plans is ended, the external schedules are ranked in the order of similarity, and then, external schedule information of high rank may be recommended to the user.

$$similarity = \frac{\vec{E} \cdot \vec{P}}{‖ \vec{E} ‖ ‖ \vec{P} ‖} \qquad [ Equation 3 ]$$

Meanwhile, in a schedule management method by means of a schedule management system using a calendar in accordance with yet another exemplary embodiment of the present disclosure, outputting of recommended schedule information may include: calculating preference of the user about each category on the basis of a similarity; selecting at least one similar user from among external users by comparing a user similarity between the calculated preference and preference of the external users about each category; and selecting recommended schedule information in consideration of preference of the selected similar user about each external schedule.

Specifically, a method of considering preference of a similar user in accordance with still another exemplary embodiment of the present disclosure (hereinafter, referred to as “cooperative filtering”) is a method of elaborating recommendation to the user using the cooperative filtering when usage information of other users as well as the user is accumulated. That is, recommendation to a specific user can be elaborated by finding v number of other users showing similar patterns to that of the specific user and analyzing tendencies and behaviors of the v number of users.

Firstly, when information about multiple users is collected, a user-schedule matrix is formed. The user-schedule matrix may include values (evaluation score, scrap, schedule reflection, etc.) representing preference of the user about a schedule.

Then, a similarity between the specific user and the other users is calculated from the user-schedule matrix, so that v number of users with the most similar preference can be found.

That is, preference of the specific user is calculated using the preference values of the v number of similar users. Assuming that a preference value of a user v about an external schedule i is r^{v,i}, an average preference value of the user v about all of schedules is r̅ᵥ, a preference prediction value of a user u about the schedule I is P_{u,i}, and a similarity between the user v and the user u is sim(u,v), P_{u,i} can be obtained as shown in Equation 4, and external schedules can be recommended in the order of preference.

$${P}_{u , i} = {\overline{r}}_{u} + \frac{{\sum }_{v ∈ V} sim ( u , v ) * ( {r}_{v , i} - {\overline{r}}_{v} )}{{\sum }_{v ∈ V} sim ( u , v )} \qquad [ Equation 4 ]$$

Finally, referring to FIG. 5, a schedule management method by means of a schedule management system using a calendar in accordance with still another exemplary embodiment of the present disclosure may include: extracting a keyword from schedule information of a user input into a calendar; outputting, on the calendar, at least one recommended schedule information selected in consideration of a similarity between the extracted keyword and a set of multiple keywords classified by category; collecting and analyzing specific recommended schedule information to which the user reacts from among the output recommended schedule information as preferred information of the user; comparing a user similarity between preference of the user about each category calculated on the basis of the similarity and preference of external users about each category and selecting at least one similar user from among the external users; and re-outputting the recommended schedule information on the calendar in consideration of at least one of the similarity, the preferred information, and preference of the selected similar user about each of external schedules.

Herein, the output recommended schedule information and the re-output recommended schedule information are added as schedule information to the calendar by selection of the user.

Specifically, referring to FIG. 5, there is insufficient information about recommended schedule usage history in early days, and, thus, a recommended schedule can be provided in consideration of preference on the basis of schedule information of the user. However, if information about recommended schedule usage history of the user is gradually increased, a recommended schedule can be provided by giving a weighting to the accumulated information. Further, if information of multiple users using the same calendar application as the user is accumulated, more accurate recommended schedule can be provided to the user using the above-described cooperative filtering.

The schedule management method by means of the schedule management system using a calendar and the schedule management apparatus described above can provide user-customized external schedule information depending on preference of the user.

According to any one of the exemplary embodiments of the present disclosure, preference about a category preferred by a user can be estimated from schedule information input into a calendar by the user. Thus, it is possible to provide recommended schedule information in consideration of preference of the user.

Further, according to an exemplary embodiment of the present disclosure, an interface through which recommended schedule information can be easily added to a digital calendar is provided. Thus, it can be helpful for a user in efficiently managing a schedule.

Furthermore, according to an exemplary embodiment of the present disclosure, the recommended schedule usage history of a user can be collected to estimate preference of the user. Thus, it is possible to provide recommended schedule information with high probability and accuracy of being preferred by the user from among external schedule information.

Moreover, according to an exemplary embodiment of the present disclosure, preference of a specific user can be estimated by collecting and analyzing information of other users having similar tendencies to that of the specific user together. Thus, it is possible to provide sufficient recommended schedule information close to the preference of the specific user.

Hereinafter, a schedule management method by means of a schedule management system using a calendar and a schedule management apparatus will be described in more detail with reference to actually implemented examples.

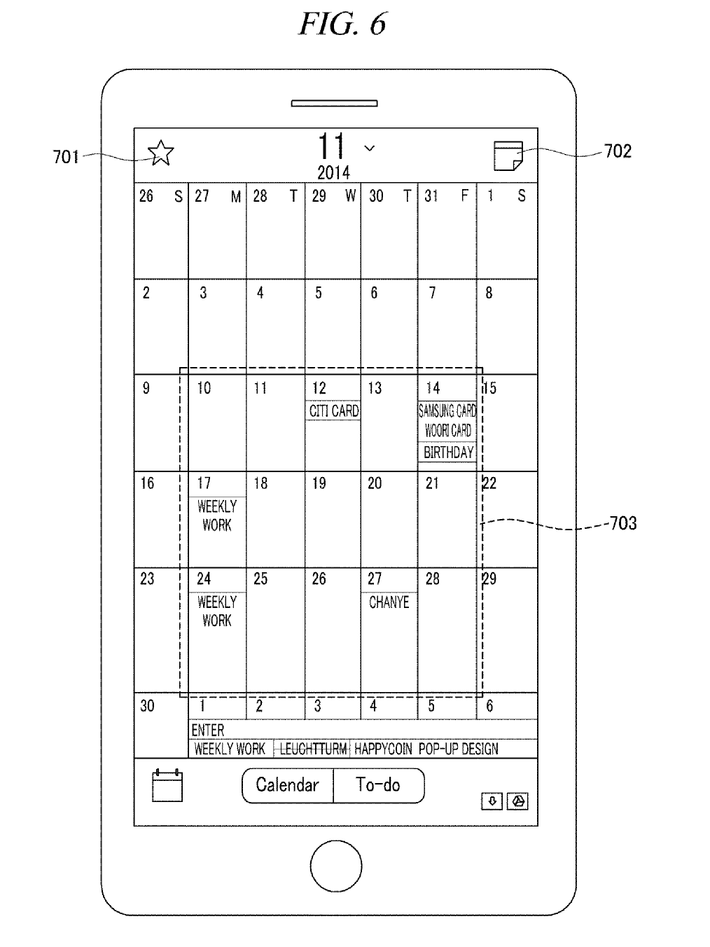

FIG. 6 illustrates an example of a user interface of a schedule management program in accordance with an exemplary embodiment.

If a schedule management application is executed in a schedule management apparatus, a calendar as illustrated in FIG. 6 is displayed on a screen of the schedule management apparatus. A user may input his/her schedule by touching a button in a schedule input area (daily schedule input area, to-do input area, and memo input area) of each calendar.

For example, the user may touch each date button (e.g., November 14), which is a daily schedule input area, of the calendar to input his/her schedule corresponding to the date. Further, the user may touch a To-do list button, which is a to-do input area, to input his/her to-do. Furthermore, the user may touch a memo button 702, which is a memo input area, to input his/her schedule.

Although not illustrated in the drawing, the memo input area may include schedule input areas (e.g., “this month”, “next month”, “next time”, and “sometime”) separated by time, and the user may select one of the separated schedule input areas to input his/her schedule.

Meanwhile, preference of the user can be calculated from all of schedule information described by the user. Thus, when an external schedule is provided, recommended schedule information can be provided in consideration of the preference of the user.

For example, schedule information 703 (e.g., “August, unpaid”, “November, health”, “Reserve bus ticket”, “Tongyeong bridge”, “Outlet”, etc.) freely described on the respective dates (daily schedule input area) of the calendar is extracted as a keyword for when, where, or what, and similarity between the extracted keyword and a set of multiple keywords representing external schedule information is calculated. In this case, preference of the user can be calculated with more accuracy in consideration of a weighting (e.g., separation of schedule input areas, separation of keywords by time, etc.). The calculated preference of the user may be used to rank and provide external schedule information or to preferentially provide a recommended schedule reflecting the preference. The recommended schedule provided as such can be checked by touching a recommended schedule lookup button 701.

FIG. 7A through FIG. 7C are diagrams provided to explain examples of the use of a recommended schedule information button in accordance with an exemplary embodiment.

The user may look up recommended schedule information (basic information or detailed information) by touching a recommended schedule information button 801. Further, the user may reflect a recommended schedule into the schedule input area (daily schedule input area, to-do input area, and memo input area) of his/her calendar as his/her schedule by scrapping the recommended schedule, dragging and dropping the recommended schedule to his/her calendar, or touching the recommended schedule for a predetermined time.

Referring to FIG. 7A, the user may look up a recommended schedule information list through a newly opened window 802 by touching the recommended schedule information button 801. In this case, the new window 802 can be freely set to be displayed on a screen in whole or in part in order to easily move a recommended schedule when dragging and dropping the recommended schedule to reflect the recommended schedule as the user's schedule.

A list of recommended schedule information 803 ranked in consideration of preference of the user about each external schedule category is displayed on the new window 802.

In this case, the user may look up basic information including a representative image, title, time, place, etc. of the recommended schedule information.

If the user wants to look up detailed information of the recommended schedule information 803, the user can look up the detailed information by touching and enlarging the recommended schedule information 803. Herein, the detailed information may include a representative image or representative video 804, reviews, evaluation scores, reservation sites, etc. of the recommended schedule information.

Meanwhile, if the user wants to reflect a recommended schedule as his/her schedule, the user may input information about the recommended schedule into the memo input area by touching a scrap button 805 within the detailed information. This will be confirmed below by explanation with reference to FIG. 8B.

Referring to FIG. 7B, the user may easily add 807 a recommended schedule to his/her daily schedule input area (each date area in the calendar) by dragging and dropping 806 recommended schedule information selected by the user to his/her calendar.

Further, referring to FIG. 7C, the user may easily add 809 a recommended schedule to his/her to-do input area (To-do-list area) by dragging and dropping 806 recommended schedule information selected by the user to his/her to-do input area.

FIG. 8A and FIG. 8B are diagrams provided to explain examples of the use of a memo input area button in accordance with an exemplary embodiment.

Referring to FIG. 8A in detail, the user may check a memo schedule stored in the memo input area by touching a memo button 901. Herein, the memo button 901 displays the number of schedules currently input in the memo input area. Thus, the user can see the number of schedules currently input in the memo area at a glance. Further, by separate settings, only the number of schedules relevant to present and future may be checked and provided.

Meanwhile, it is possible to easily and freely add a schedule already described in the memo input area to the daily schedule input area by dragging and dropping 902 the schedule to the user's calendar. For example, a schedule “change engine oil” input in an input area “this month” in the memo input area can be dragged and dropped 902 to the calendar, and, thus, the schedule (i.e., “change engine oil”) can be moved and input to a specific date in the calendar.

A method of adding a schedule to the daily schedule input area is not limited to the dragging and dropping, but may include various methods such as clicking for a predetermined period of time or more.

Referring to FIG. 8B in detail, it is possible to add memo schedules using a memo schedule input button 906 in the memo input area. The memo schedule input area includes schedule input areas (e.g., “this month”, “next month”, “next time”, and “sometime”) 905 separated by time.

Meanwhile, the memo schedules added using the memo schedule input button 906 are stored in sequence without separation by time. Herein, the memo schedules stored therein are dragged and dropped 907 to the spaces 905 separated by time and thus can be input into the memo input areas separated by time.

Further, as described above with reference to FIG. 7A, if a recommended schedule is scrapped, the recommended schedule is input into the user's memo input area, and the input information can be checked from a separate space 904 displayed on a lower part of the memo schedule input area.

The schedule management method by means of the schedule management system using a calendar and the schedule management apparatus in accordance with exemplary embodiments can be embodied in a storage medium including instruction codes executable by a computer or processor such as a program module executed by the computer or processor. A data structure in accordance with the exemplary embodiments can be stored in the storage medium executable by the computer or processor. A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as a computer-readable instruction code, a data structure, a program module or other data. The communication medium typically includes the computer-readable instruction code, the data structure, the program module, or other data of a modulated data signal such as a carrier wave, or other transmission mechanism, and includes a certain information transmission medium.

The system and method of the present disclosure has been explained in relation to a specific embodiment, but its components or a part or all of its operations can be embodied by using a computer system having general-purpose hardware architecture.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A schedule management method performed by a schedule management system using a calendar, the schedule management method comprising:
extracting a keyword from schedule information of a user input into multiple schedule input areas in the calendar; and
outputting, on a schedule management apparatus of the schedule management system, at least one recommended schedule information selected in consideration of a similarity value between the extracted keyword and a set of multiple keywords classified by category,
wherein the recommended schedule information is able to be added to a schedule input area on the calendar by selection of the user.

2. The schedule management method of claim 1, further comprising:
identifying a schedule input area where the schedule information is input from among the multiple schedule input areas in the calendar,
wherein the outputting of at least one recommended schedule information comprises calculating the similarity value by giving a similarity value of each extracted keyword a different weighting depending on the identified schedule input area.

3. The schedule management method of claim 2,
wherein the multiple schedule input areas include a daily schedule input area and a to-do input area provided for each date and a memo input area, and
the highest weighting is given to schedule information input into the daily schedule input area among the multiple schedule input areas, and the lowest weighting is given to schedule information input into the memo input area among the multiple schedule input areas.

4. The schedule management method of claim 2,
wherein the schedule information includes information relevant to a future time for executing a schedule by the user, and
the outputting of at least one recommended schedule information comprises calculating the similarity value by giving a higher weighting when an execution time of the schedule information is closer to when the recommended schedule information is provided to the user.

5. The schedule management method of claim 1,
wherein the outputting of at least one recommended schedule information includes:
calculating preference of the user about each category on the basis of the similarity value;
detecting multiple external schedule information corresponding to each category; and
determining the order of outputting the recommended schedule information through an operation on the basis of the calculated preference and each of the external schedule information.

6. The schedule management method of claim 1, further comprising:
identifying the user through a log-in process; and
collecting and analyzing specific recommended schedule information to which the identified user reacts from among the output recommended schedule information as preferred information of the identified user,
wherein in the outputting of at least one recommended schedule information, the recommended schedule information is selected in consideration of the similarity value and the preferred information.

7. The schedule management method of claim 6,
wherein the specific recommended schedule information is at least any one of recommended schedule information clicked at least a reference number of times, recommended schedule information given a minimum or higher evaluation score, recommended schedule information added as schedule information to the calendar, and recommended schedule information scrapped to the schedule input area.

8. The schedule management method of claim 1,
wherein the outputting of at least one recommended schedule information includes:
calculating preference of the user about each category on the basis of the similarity value;
selecting at least one similar user from among external users by comparing a user similarity value between the calculated preference and preference of the external users about each category; and
selecting the recommended schedule information in consideration of preference of the selected similar user about each external schedule.

9. The schedule management method of claim 1, further comprising:
after the outputting on the calendar,
collecting and analyzing specific recommended schedule information to which the user reacts from among the output recommended schedule information as preferred information of the user;
comparing a user similarity value between preference of the user about each category calculated on the basis of the similarity value and preference of external users about each category and selecting at least one similar user from among the external users; and
re-outputting the recommended schedule information on the calendar in consideration of at least one of the similarity value, the preferred information, and preference of the selected similar user about each external schedule,
wherein the output recommended schedule information and the re-output recommended schedule information are added as schedule information to the calendar by selection of the user.

10. The schedule management method of claim 1, further comprising:
after the extracting of a keyword,
creating recommended scheduled information on the basis of a similarity value between external schedule information received from an external schedule database and schedule information of the user,
wherein in the creating of recommended scheduled information, the external schedule information is ranked on the basis of a similarity value the extracted keyword and keywords defining a category classifying the external schedule information, and when the similarity value is calculated, a higher weighting is given to schedule information of the user of which an execution time is closer to when the recommended schedule information is provided to the user.

11. A schedule management apparatus using a calendar, comprising:
a memory in which a calendar program managing a schedule is stored; and
a processor which executes the calendar program,
wherein the processor performs:
extracting a keyword from schedule information of a user input into multiple schedule input areas in a calendar provided by the calendar program; and
outputting, on a screen of the schedule management apparatus, at least one recommended schedule information selected in consideration of a similarity value between the extracted keyword and a set of multiple keywords classified by category, in response to an instruction of the calendar program, and
the recommended schedule information is able to be added to a schedule input area on the calendar by selection of the user.

12. The schedule management apparatus of claim 11, further comprising:
a communication module that receives multiple external schedule information from a server,
wherein the processor outputs, on the screen, the recommended schedule information selected from among the multiple external schedule information.

13. The schedule management apparatus of claim 12,
wherein the recommended schedule information is selected from the server on the basis of preference of a similar user about each external schedule, and
the similar user is selected as at least one of external users by calculating preference of the user about each category on the basis of the similarity value and comparing a user similarity value between the calculated similarity value and preference of the external users about each category.

14. The schedule management apparatus of claim 12,
wherein the communication module transmits, to the server, preference of the user about each category calculated on the basis of the similarity value by the processor, and receives information about a similar user from the server,
the processor performs selecting the recommended schedule information in consideration of preference of the similar user about each external schedule in the outputting of the recommended schedule information, and
the similar user is selected by the server on the basis of a user similarity value between the transmitted preference and preference of external users about each category.

15. A schedule management method by a schedule management system using a calendar, the schedule management method comprising,
creating a user profile on the basis of a usage history of a user about recommended schedule information provided to the user;
creating recommended schedule information on the basis of a similarity value between the user profile and external schedule information received from an external schedule database; and
outputting the recommended schedule information on a schedule management apparatus of the schedule management system,
wherein the user profile includes keyword information representing schedule information determined as being preferred by the user on the basis of the usage history,
in the creating of recommended schedule information, the external schedule information is ranked and produced on the basis of a similarity value between a keyword included in the user profile and keywords defining a category classifying the external schedule information, and
in the creating of a user profile, schedule information preferred by the user is checked on the basis of any one or more of whether or not the user scraps the recommended schedule information or whether or not the user reflects the recommended schedule information as a schedule of the user.

16. The schedule management method of claim 15,
wherein in the creating recommended schedule information, the similarity value is calculated by setting a different weighting depending on an execution time of schedule information determined as being preferred by the user.

17. The schedule management method of claim 15,
wherein in the creating of a user profile, the user profile is created on the basis of schedule information of the user input into the calendar and the usage history of the user about the recommended schedule information provided to the user, and
in the creating of recommended schedule information, the external schedule information is ranked and produced on the basis of the similarity value between the keyword included in the user profile and keywords not included in the user profile among keywords of the external schedule information.
